(19) United States
(12) Patent Application Publication
(10) Pub. No.: US 2026/0002890 A1
(43) Pub. Date: Jan. 1, 2026

(54) SOLDER MATERIAL WITH CONTRAST AGENT

(71) Applicant: Kyzen Corporation, Nashville, TN (US)

(72) Inventors: Adam Klett, Mt. Juliet, TN (US); James Franklin Perigen, Lebanon, TN (US)

(21) Appl. No.: 19/251,514

(22) Filed: Jun. 26, 2025

Related U.S. Application Data
(60) Provisional application No. 63/664,867, filed on Jun. 27, 2024.

(51) Int. Cl. G01N 23/046; B23K 35/36; G01N 23/083

(52) U.S. Cl. CPC G01N 23/046; B23K 35/36; G01N 23/083; G01N 2223/6113

(57) ABSTRACT

An electrical connection material having a contrast agent infused within, and related systems and methods of detection thereof, are disclosed herein. Computer electronics such as printed circuit boards have electronic components attached to a substrate by an electrical connection material. The electrical connection material has at least one component infused with a contrast agent. The contrast agent is of a concentration to provide a visual distinction or highlight when imaged by an inspection system, such as an x-ray system of computed tomography (CT) scanning system. The presence of the contrast agent demonstrates that not all of residual electrical connection material has been cleaned away from the printed circuit board after manufacture.

### CROSS REFERENCE TO RELATED APPLICATIONS

This application claims the benefit of the filing date of U.S. Provisional Application No. 63/664,867 filed on Jun. 27, 2024, and which is currently pending.

### TECHNICAL FIELD

The present disclosure generally relates to solder material, and more particularly to systems and methods for inspecting a printed circuit board for residue beneath an electrical component placed on the printed circuit board with the solder material.

### BACKGROUND

The present disclosure generally relates to solder material, and more particularly to systems and methods for inspecting a substrate in electrical applications, and in some embodiments printed circuit boards, for residue beneath an electrical component placed on the printed circuit board with the solder material. In the manufacturing process of electronic parts, such as printed circuit boards, individual components will need to be joined using an electrically conductive metallic bond. This bond is typically formed by soldering the components together or soldering the components to a substrate such as printed circuit board. The soldering process requires the parts be joined together using solder material, such as solder wire, solder paste, solder resin, and a solder flux. The solder flux removes metal oxides from the solder, aids in the wetting of the components by the molten metal, and protects the metal from re-oxidation. Most of the solder flux decomposes, however some remains behind as residue after the soldering process. The residue is undesirable in high reliability electronics, as it can negatively impact the functionality and reliability of the electronic assembly, and must be removed. What is needed are systems and methods that accurately identify residue so it can be properly removed and confirmed as removed from the electronics afterwards.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure generally relates to solder material with contrast agent, and more particularly to systems and methods for inspecting a printed circuit board for residue beneath an electrical component placed on the printed circuit board with the solder material with contrast agent. In the manufacturing process of electronic parts, such as printed circuit boards (PCBs), individual components will need to be joined using an electrically conductive metallic bond. This bond is typically formed by soldering the components together or soldering the components to a circuit board. The soldering process requires the parts be joined together using solder material, such as solder and a solder flux. The solder flux removes metal oxides from the solder, aids in the wetting of the components by the molten metal, and protects the metal from re-oxidation. Most of the solder flux decomposes, however some remains behind as residue after the soldering process. The residue is undesirable in high reliability electronics, as it can negatively impact the functionality and reliability of the electronic assembly, such as by causing corrosion of any metals in the electronic assembly during operation, which can lead to failure of the electronics. Thus it is beneficial to remove any such residue after the soldering is complete. Embodiments of the present disclosure provide a solder material infused with a contrast agent that can be used for soldering components onto a PCB so that residue can be easily identified by scanning the PCB with a suitable inspection system which can identify the contrast agent, including but not limited to x-ray inspection systems and computed tomography (CT) scanning systems. The contrast agent can be used to increase the contrast within residues under or near electrical components of the PCB by absorbing or changing the way that electromagnetic radiation passes through such residues on the PCB when scanned using radiographic imaging (e.g., X-ray, CT scan, MRI). The resulting radiographic images can highlight the residue left on and around the electrical components because the contrast agent altered the contrast of the residue by absorbing or changing the way that the radiation passed through the residue compared to the electrical components of the PCB. If residue is detected in the radiographic images, then the PCB can be cleaned again to remove the residues and scanned again with the x-ray inspection system to confirm when the residue has been removed, resulting in functional and reliable electronics.

One aspect of the present disclosure is an electrical connection material including a solder material for connecting an electrical component to a printed circuit board. The solder material can include one or more of solder wire, solder resin, solder paste, or solder flux. In some embodiments, the solder wire, solder paste, or solder resin of the solder material may have an electrical conductivity of at least 8% IACS to facilitate an electrical connection between components on the PCB. The electrical connection material may include a contrast agent, wherein the concentration of contrast agent within the electrical connection material is at least 0.1 percent by weight. It will be readily understood that if the contrast agent is present in the electrically conductive solder material, such as solder wire, solder paste, or solder resin, the weight percentage of the contrast agent may be relatively smaller as such electrically conductive solder materials generally include heavier metals, whereas if the contrast agent is present in the solder flux the weight percentage may be higher as the solder flux is lighter.

Another aspect of the present disclosure is a system for inspecting a printed circuit board for residue beneath an electrical component. The system may include an electrical connection material comprising a solder material infused with a contrast agent and applied to the printed circuit board for connecting the electrical component to the printed circuit board. The system may include an x-ray inspection system operable to generate one or more radiographic images of the printed circuit board including the connected electrical component, wherein the residue is highlighted in the one or more radiographic images of the printed circuit board due to the contrast agent.

Another aspect of the present disclosure is a method. The method may include a method for inspecting a printed circuit board for residue. The method may include applying electrical connection material to the printed circuit board, the electrical connection material having a solder material infused with a contrast agent. The method may include placing an electrical component in contact with the electrical connection material. The method may include heating the solder material to connect the electrical component to the printed circuit board. The method may include scanning the printed circuit board with an x-ray inspection system to generate one or more radiographic images of the printed circuit board. The method may include analyzing the one or more radiographic images of the printed circuit board for residue, wherein the residue is highlighted in the one or more radiographic images of the printed circuit board due to the contrast agent.

Numerous other objects, advantages, and features of the present disclosure will be readily apparent to those of skill in the art upon a review of the following drawings and description of various embodiments.

### BRIEF DESCRIPTION OF THE DRAWINGS

The accompanying drawings, which are incorporated in and constitute a part of the specification, illustrate exemplary embodiments of the disclosure. Together with the description, they serve to explain the objects, advantages, and principles of the disclosure.

FIG. 1 is a block diagram illustrating an example embodiment of a system of the present disclosure.

FIGS. 2A-2D are a series of images of an electrical component taken by a suitable inspection system, according to example embodiments of the present disclosure.

FIG. 3 is a flowchart diagram illustrating an example embodiment of a method of the present disclosure.

### DETAILED DESCRIPTION

Reference will now be made in detail to exemplary embodiments of the disclosure, some aspects of which are illustrated in the accompanying drawings.

The present disclosure generally relates to solder material with contrast agent, and more particularly to systems and methods for inspecting a printed circuit board (PCB) for residue near or beneath an electrical component placed on the PCB with the solder material with contrast agent. In the manufacturing process of electronic parts, such as printed circuit boards, individual components, such as semiconductor computer chips, transistors, diodes, resistors, and capacitors, will need to be joined using an electrically conductive metallic bond. This bond is typically formed by soldering the components together or soldering the components to a circuit board. The soldering process requires the parts be joined together using solder material, such as solder and a solder flux. Solder flux is a multiple component mixture that typically consists of resins, activators, rheological additives, and a solvent. If the solder flux is incorporated into a solder paste, it will be mixed with fine particles of the metallic solder. The solder flux removes metal oxides from the solder, aids in the wetting of the components by the molten metal, and protects the metal from re-oxidation. Most of the solder flux decomposes, however some remains behind as residue after the soldering process. For example, the residue may be underneath the components soldered onto the PCB. The residue is undesirable in high reliability electronics, as it can negatively impact the functionality and reliability of the electronic assembly.

Generally, in the high reliability manufacturing process, residue is considered a contamination and must be removed. For instance, contamination on electronics, such as printed circuit boards (PCBs), is a concern for the reliability of the entire assembly or product that contains the electronics. In PCB manufacturing, a soldering process may be used to attach electrical components to a PCB. Electrically conductive solder material, such as solder wire, solder paste, or solder resin can be applied to locations on the PCB where the electrical components are to be attached, and the electrical components can be placed onto the solder paste. Solder flux can used with the electrically conductive solder material to help bond the solder to the PCB. The PCB is heated so that the solder paste melts and then cools, thereby creating a solid connection between the electrical components and the PCB. Several types of soldering processes are well-known in the industry and any suitable soldering process can be utilized. Such soldering processes can include, but are not limited to, solder reflow processing, wave soldering, hand soldering, etc. The resulting PCB can be used in an electronic device, such as a computer, medical device, automobile, or consumer electronic equipment. However, the solder flux component of the solder paste may leave behind flux residue. While the long-term reliability of electronics may be less concerning with consumer electronics applications, there are many industries (e.g., military, medical, capital equipment, aerospace, industrial, and oil exploration industries) where failure of electronics is considered unacceptable and extremely costly. This is primarily due to the risk of loss of life incidents, an expensive or lengthy period of inoperability of the equipment leading to a large, unexpected cost, or industry regulations. Therefore, the residue needs to be accurately identified so it can be properly removed and confirmed as removed from the electronics afterwards.

Contrast agents or contrast mediums are chemical substances that can be used to increase the contrast of structures by absorbing or changing the way that electromagnetic radiation passes through the structures the contrast agent was applied to. When the structures with the contrast agent are scanned using radiographic imaging (e.g., X-ray, CT scan, MRI), the structures are highlighted in the resulting radiographic images. Embodiments of the present disclosure provide a solder material (e.g., solder wire, solder paste, solder resin, and solder flux) infused with a contrast agent that can be used for soldering components onto a PCB so that residue can be easily identified by scanning the PCB with a suitable inspection system, such as an x-ray scanning system or computed tomography (CT) scanning system.

The present disclosure provides systems and methods for inspecting a PCB for residue near and/or beneath an electrical component connected to the PCB with solder material infused with contrast agent by scanning the PCB using an x-ray inspection system to produce radiographic images highlighting the residue. The solder material, such as solder wire, solder paste, and/or flux material, can be infused with the contrast agent. For example, the concentration of the contrast agent within the solder material may be between 0.5 percent by weight and 30 percent by weight depending on the solder material being infused with the contrast agent. In some embodiments, the infused solder material can be applied to a PCB and electrical components can be placed on top of the infused solder material, then heated and cooled (e.g., solder paste infused with contrast agent). In other embodiments, the infused solder material may be used to solder an electrical component to the PCB (e.g., solder wire infused with contrast agent). In other embodiments the contrast agent can be infused in the solder flux material as opposed to the electrically conductive solder material (Solder paste, wire, or resin). Flux used in the infused solder paste or in the soldering process can remove metal oxides from the solder but leave residue on or around the electrical components that the solder material was applied to. A suitable imaging or inspection system, such as an x-ray machine, a CT scan, or an MRI, can be used to scan the PCB, which will generate radiographic images that highlight the residue left behind by the infused solder material because of the contrast agent. For example, a CT scan of the PCB can use irradiation to produce two-dimensional and/or three-dimension images of the electrical components connected to the PCB with the infused solder material. The resulting images will clearly show where residue remains beneath the electrical components via highlighting or coloring the residue because the contrast agent altered the contrast of the residue by absorbing or changing the way that the radiation passed through the residue compared to the solder and electrical components of the PCB.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type may be referred to as “Elements 102(1)-(n)” where n may include a number. Referring to one of the elements as “Element 102” refers to any single element of the Elements 102(1)-(n). Additionally, referring to different elements “First Elements 102(1)-(n)” and “Second Elements 104(1)-(n)” does not necessarily mean that there must be the same number of First Elements as Second Elements and is equivalent to “First Elements 102(1)-(n)” and “Second Elements(1)-(m)” where m is a number that may be the same or may be a different number than n.

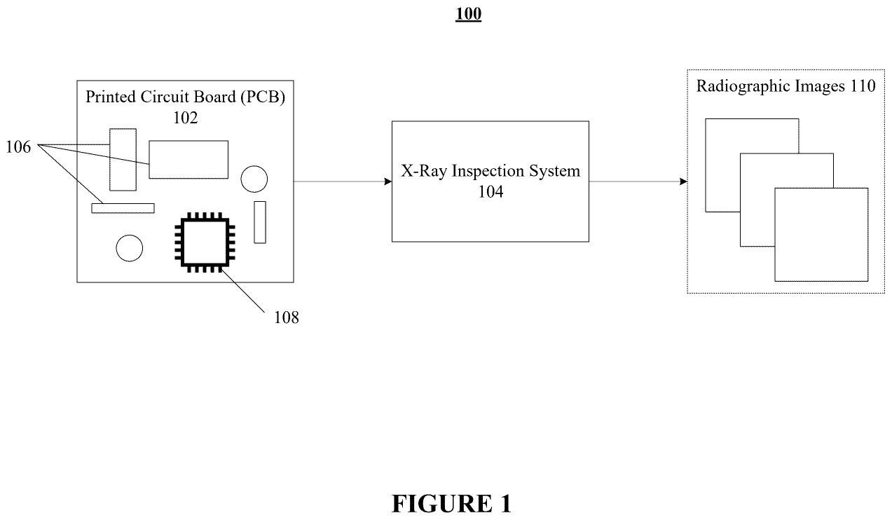

FIG. 1 is a block diagram illustrating an example embodiment of a system 100 of the present disclosure. The system 100 may include a printed circuit board (PCB) 102, an electrical connection material, and an x-ray inspection system 104. The electrical connection material can include solder material infused with a contrast agent. The solder material can include at least one of solder paste, solder wire, solder resin, or solder flux. The solder material allows for electrical components to become attached to the PCB. The electrically conductive components of the solder material (solder paste, solder wire, solder resin) may be material with an electrical conductivity of at least 8% IACS (International Annealed Copper Standard). For example, the solder material may be solder paste with an electrical conductivity of at least 8% IACS that includes a combination of powdered solder alloy (e.g., a combination of tin and lead) and flux paste (e.g., a mixture of resins, activators, and/or rheological additives, and a solvent) that holds electrical components 106 in place, and when the solder paste is melted and cooled, the electrical components 106 become attached to the PCB 102. The contrast agent may contain at least one element having an atomic number of at least 11, such as an iodinated contrast agent, a barium-based contrast agent (e.g., barium-sulfate (BaSO₄)), or a gadolinium-based contrast agent. At least one component of the solder material can be infused with the contrast agent to create the electrical connection material. For example, the contrast agent may be mixed with or suspended in the solder material. For instance, the contrast agent may be mixed with or suspended in one or more of solder resin, solder paste, solder wire, and/or flux material to create the electrical connection material. In some embodiments, an electrically conductive component of the solder material, such as a solder wire, solder paste, or solder resin, can be infused with the contrast agent, and the solder flux may additionally be infused with the contrast agent. In other embodiments, only the solder flux or the electrically conductive solder material may be infused with the contrast agent.

Generally, a sufficient concentration of the contrast agent should be provided within the electrical connection material such that the contrast agent appears visually distinct when an image is taken of the PCB using an x-ray inspection system, computed tomography (CT) scanning inspection system, or other optical inspection system. An optical inspection system is any device capable of scanning, imaging, inspecting, or otherwise analyzing a component and providing an optical output such as an image, photograph, motion video, scan, figure, or other representational visible display. Using current CT technology, it has been determined that a contrast agent in the amount of approximately 0.1 percent by weight is the lower bound of concentration that may still result in a visual distinction on a CT scan image of the PCB to indicate presence of the electrical connection material. Future improvements to CT scanning systems, X-ray systems, or other optical inspection systems may result in greater sensitivity or resolution, such that concentrations less than 0.1 percent by weight of contrast agent within the electrical connection material may be used. In other words, the current limiting amount for a minimal concentration of the contrast agent is the sensitivity of the optical inspection system to detect and distinguish the contrast agent in an output image, not something inherent in the contrast agent itself. So long as the concentration of the contrast agent is sufficient to result in a visual distinction when detected by the optical inspection system, such amount of contrast agent is within the scope of this disclosure.

On the other end, the only limitation on the maximum concentration of contrast agent is such that it otherwise prevents the general effectivity of the electrical connection material from performing its function to connect the electrical component to the substrate of the PCB. Testing up to a concentration of approximately 42 percent by weight has been conducted showing that the contrast agent is visually distinctive in a resulting scan and the electrical connection material continues to perform sufficiently to not degrade the structure, performance, or operation of the PCB.

Without otherwise limiting the foregoing, in some embodiments, the concentration of the contrast agent within the electrical connection material is at least 0.1 percent by weight. In some embodiments, the concentration of the contrast agent within the electrical connection material is 40 percent by weight, or higher. For example, the concentration of the contrast agent within the electrical connection material may be between 0.1 percent by weight and 40 percent by weight.

In some implementations, the concentration of the contrast agent within the electrical connection material may be between 0.5 percent by weight and 10 percent by weight. In some implementations, the concentration of the contrast agent within the electrical connection material may be between 1 percent by weight and 10 percent by weight. In some implementations, the concentration of the contrast agent within the electrical connection material may be between 1 percent by weight and 9 percent by weight. In some implementations, the concentration of the contrast agent within the electrical connection material may be between 1 percent by weight and 8 percent by weight. In some implementations, the concentration of the contrast agent within the electrical connection material may be between 1 percent by weight and 7 percent by weight. In some implementations, the concentration of the contrast agent within the electrical connection material may be between 1 percent by weight and 6 percent by weight. In some implementations, the concentration of the contrast agent within the electrical connection material may be between 1 percent by weight and 5 percent by weight. In some implementations, the concentration of the contrast agent within the electrical connection material may be between 1 percent by weight and 4 percent by weight. In some implementations, the concentration of the contrast agent within the electrical connection material may be between 1 percent by weight and 3 percent by weight. In some implementations, the concentration of the contrast agent within the electrical connection material may be between 1 percent by weight and 2 percent by weight.

In some implementations, the concentration of the contrast agent within the electrical connection material may be between 0.1 percent by weight and 3 percent by weight. In some implementations, the concentration of the contrast agent within the electrical connection material may be between 0.1 percent by weight and 2 percent by weight. In some implementations, the concentration of the contrast agent within the electrical connection material may be between 0.5 percent by weight and 3 percent by weight. In some implementations, the concentration of the contrast agent within the electrical connection material may be between 0.5 percent by weight and 2 percent by weight. In other embodiments, the concentration of the contrast agent within the electrical connection material may be between 0.1 and 30 percent by weight, between 0.5 and 30 percent by weight between 0.5 and 20 percent by weight; between.5 and 15 percent by weight; between 1 and 20 percent by weight; between 1 and 15 percent by weight; between 2 and 20 percent by weight; between 2 and 15 percent by weight.

It will be understood that the weight composition of the contrast agent will depend heavily on the type of contrast agent used as well as the weight of the underlying solder material. For instance, contrast agents in a solder flux material may have a higher weight percentage than if the contrast agent was in heavier, electrically conductive solder materials such as solder wire, paste, or resin, as solder flux tends to be lighter. Additionally, contrast agents with elements having higher atomic numbers may be heavier and thus have higher weight concentrations. It will also be apparent to one of skill in the art that the weight concentration of the contrast agent can generally be optimized to maximize the ability of the inspection system to accurately pick up the contrast agent when the PCB is scanned, while not negatively impact the performance and reliability of the electrical connection being established by the electrical connection material.

In some implementations, the concentration of the contrast agent within the electrical connection material may be between 2 percent by weight and 9 percent by weight. In some implementations, the concentration of the contrast agent within the electrical connection material may be between 3 percent by weight and 8 percent by weight. In some implementations, the concentration of the contrast agent within the electrical connection material may be between 4 percent by weight and 7 percent by weight. In some implementations, the concentration of the contrast agent within the electrical connection material may be between 5 percent by weight and 6 percent by weight.

The electrical connection material (i.e., the solder material infused with contrast agent) can be applied to the PCB to allow for connecting an electrical component onto the PCB. For example, in stencil printing, a stencil of the PCB layout can be placed on the PCB, a printer can spread the electrical connection material across the stencil on the PCB, and then electrical components can be placed on the electrical connection material by a pick and place machine. The electrical components can be placed such that the electrical components are in contact with the electrical connection material that has been applied to the PCB. The solder material (e.g., solder paste) within the electrical connection material can be heated to a temperature that melts the solder material to a consistency that allows the electrical components that are in contact with the electrical connection material to adhere to the PCB when the solder material is cooled. For example, the PCB with the electrical components placed in contact with the electrical connection material can be inserted into a solder reflow oven to melt the solder material, which is a component of the electrical connection material, and then cool the solder material such that the electrical component is solidly connected to the PCB both electrically and mechanically. The solder material may have flux in it to remove metal oxides from the solder, aid in the wetting of the components by the molten metal, and protect the metal from re-oxidation, however the flux can leave residue on the electrical components and/or the PCB after the heating process. Additionally, the solder component of the solder material may leave residue on the electrical components and/or the PCB. For example, the residue may be deposited near and/or beneath one or more of the components that were soldered (i.e., heating and cooling the solder material) onto the PCB via the electrical connection material. If the residue is not properly removed from the PCB, the residue can be harmful to the PCB, such as by corroding other components of the electronic device during operation and causing failure of the electronic device with the PCB. Accurately detecting residue can allow for identification of areas where residue resides on the PCB so that the residue can be removed.

An optical inspection system, such as an x-ray inspection system can be used to detect residue on the PCB or its components. In the following discussion, optical inspection systems are described that produce visible images using radiographic scanning methods. Such optical inspection systems include x-ray inspection systems and CT scanning inspection systems. Other methods may be used to product visible images capable of detecting the presence of a contrast agent on the PCB without departing from the scope of the disclosure.

In some embodiments, the x-ray inspection system 104 may be a computed tomography (CT) scan. Prior to scanning the PCB with the x-ray inspection system, the PCB can be cleaned using a variety of methods, such as solvent cleaning, immersion cleaning, and ultrasonic cleaning. The x-ray inspection system can scan the PCB and generate radiographic images 110 of the PCB and its connected electrical components. The radiographic images can highlight the residue due to the contrast agent in the electrical connection material that was used to connect the electrical components to the PCB. For example, a CT scan of the PCB can use irradiation to produce two-dimensional and/or three-dimension radiographic images of the electrical components connected to the PCB with the electrical connection material (i.e., the solder material infused with the contrast agent). The resulting images will clearly show where residue remains beneath the electrical components via highlighting or coloring the residue because the contrast agent altered the contrast of the residue by absorbing or changing the way that the radiation passed through the residue compared to the solder and electrical components of the PCB. If residue is detected in the radiographic images, then the PCB can be cleaned again to remove the residues and scanned again with the x-ray inspection system to confirm whether the residue has been removed.

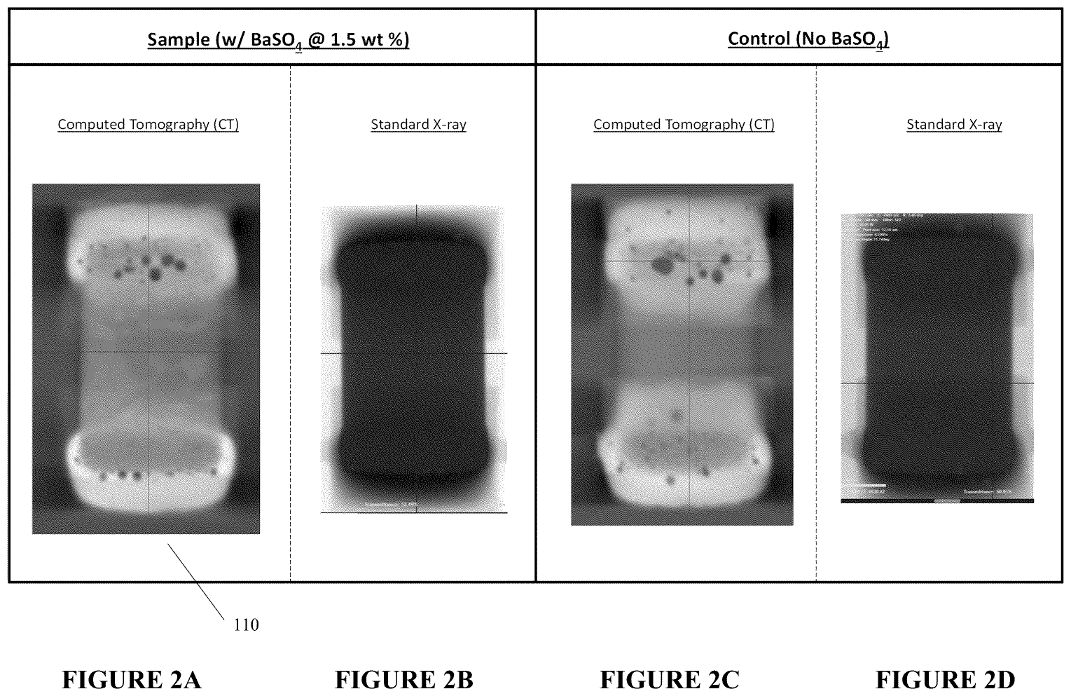

FIGS. 2A-2D are a series of radiographic images of an electrical component according to example embodiments of the present disclosure. The radiographic images 110 of the PCB generated by using the x-ray inspection system to scan the PCB can highlight the residue due to the contrast agent in the electrical connection material that was used to connect the electrical components to the PCB. FIG. 2A depicts a CT scan image of an electrical component connected to the PCB with the electrical connection material, where the electrical connection material contains solder material infused with barium-sulfate as the contrast agent, and FIG. 2C depicts a CT scan image of an electrical component connected to the PCB with electrical connection material that does not contain any contrast agent. The residue can be identified in the CT scan image of the electrical component that was connected to the PCB with the electrical connection material that contains the solder material infused with barium-sulfate as the contrast agent, whereas the residue is not visible by the CT scanning system in the sample without a contrast agent. FIGS. 2B and 2D depict a standard x-ray image produced by scanning a PCB with electrical components connected to the PCB via the electrical connection material with the contrast agent and by scanning a PCB with electrical components connected to the PCB electrical connection material without contrast agent, which both render the residue unidentifiable, showing that higher weight concentrations of the contrast agent are needed to be visible with standard X-ray imaging.

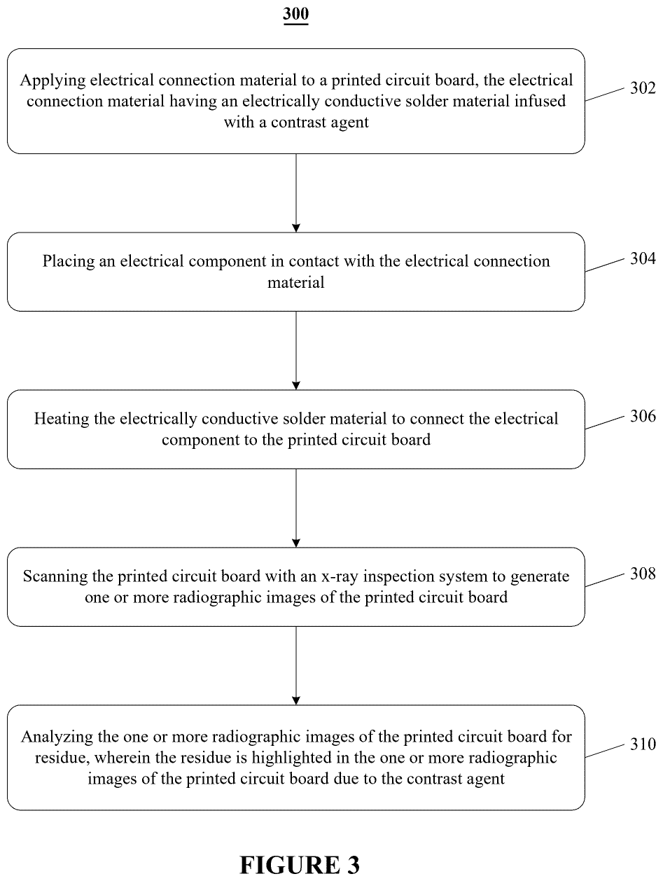

FIG. 3 is a flowchart diagram illustrating an example embodiment of a method 300 of the present disclosure. The method 300 for inspecting a printed circuit board for residue may include operation 302 of applying electrical connection material to the printed circuit board, the electrical connection material having a solder material infused with a contrast agent. The solder material may include solder wire, solder paste, flux, or a combination thereof. The contrast agent may include at least one element that has an atomic number of at least 11. For example in some embodiments, the contrast can include, but is not limited to, an iodinated contrast agent, a barium-based contrast agent, or a gadolinium-based contrast agent. The method 300 for inspecting a printed circuit board for residue may include operation 304 of placing an electrical component in contact with the electrical connection material. The method 300 for inspecting a printed circuit board for residue may include operation 306 of heating the solder material to connect the electrical component to the printed circuit board. The method 300 for inspecting a printed circuit board for residue may include operation 308 of scanning the printed circuit board with an x-ray inspection system to generate one or more radiographic images of the printed circuit board. The x-ray inspection system may include a computed tomography (CT) scan. The method 300 for inspecting a printed circuit board for residue may include operation 310 of analyzing the one or more radiographic images of the printed circuit board for residue, wherein the residue is highlighted in the one or more radiographic images of the printed circuit board due to the contrast agent. The residue may be deposited beneath a component (e.g., the electrical component) soldered onto the printed circuit board via the electrical connection material.

The presently disclosed systems and methods have a wide application anywhere in the electronics industry where inspecting a printed circuit board for residue is needed. One particularly important application for the systems and methods described herein relates to printed circuit board assembly. Additional systems and methods include applications in electronics assemblies and other types of circuit boards. However, the systems and methods described above could be utilized in other contexts.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those skilled in the art will recognize, or be able to ascertain, using no more than routine experimentation, numerous equivalents to the specific substances and procedures described herein. Such equivalents are considered to be within the scope of this disclosure and are covered by the following exemplary claims.

Furthermore, the described features, structures, or characteristics of the disclosure may be combined in any suitable manner in one or more embodiments. In the description contained herein, numerous specific details are provided to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

What is claimed is:

1. An electrical connection material for connecting an electrical component to a substrate, the electrical connection material comprising:
a solder material including at least one component selected from the group of solder wire, solder paste, solder resin, and solder flux;
wherein the at least one component includes a contrast agent, wherein the concentration of contrast agent within the at least one component of the solder material is sufficient to be visually distinct when the electrical connection material is imaged by an imaging device.

2. The electrical connection material of claim 1, wherein the contrast agent is of a concentration between 0.1 percent and 45 percent by weight of the electrical connection material.

3. The electrical connection material of claim 1, wherein the contrast agent is of a concentration between 0.5 percent and 40 percent by weight of the electrical connection material.

4. The electrical connection material of claim 1, wherein the contrast agent is of a concentration between 1 percent and 10 percent by weight of the electrical connection material.

5. The electrical connection material of claim 1, wherein the contrast agent is selected from a group consisting of an iodine-based contrast agent, a barium-based contrast agent, and a gadolinium-based contrast agent.

6. A system for inspecting a substrate for residue beneath an electrical component, comprising:
an electrical connection material comprising a solder material including at least component selected from the group of solder wire, solder paste, solder resin, and solder flux, wherein the at least one component of the solder material is infused with a contrast agent, the electrical connection material being applicable to the substrate for connecting the electrical component to the substrate; and
an inspection system operable to generate one or more images of the substrate including the connected electrical component, wherein the residue is highlighted in the one or more images of the substrate due to the contrast agent.

7. The system of claim 6, wherein the contrast agent is of a concentration between 0.1 percent and 45 percent by weight of the electrical connection material.

8. The system of claim 6, wherein the contrast agent is of a concentration between 0.5 percent and 40 percent by weight of the electrical connection material.

9. The system of claim 6, wherein the contrast agent is of a concentration between 1 percent and 10 percent by weight of the electrical connection material.

10. The system of claim 6, wherein the inspection system generates radiographic images.

11. The system of claim 10, wherein the inspection system is an x-ray system.

12. The system of claim 10, wherein the inspection system is a CT scanning system.

13. A method for inspecting a substrate for residue, comprising:
Applying an electrical connection material to a printed circuit board, the electrical connection material having a solder material including at least one component selected from a group consisting of solder wire, solder paste, solder resin, and solder flux, wherein the at least one component of the solder material is infused with a contrast agent;
placing an electrical component in contact with the electrical connection material;
heating the solder material to connect the electrical component to the printed circuit board;
scanning the substrate with an inspection system to generate one or more images of the printed circuit board; and
analyzing the one or more images of the substrate for residue, wherein the residue is highlighted in the one or more images of the substrate due to the contrast agent.

14. The method of claim 13, wherein the contrast agent is selected from a group consisting of an iodine-based contrast agent, a barium-based contrast agent, and a gadolinium-based contrast agent.

15. The method of claim 13, wherein the contrast agent has at least one element having an atomic number of at least 11.

16. The method of claim 13, wherein the inspection system generates one or more radiographic images.

17. The method of claim 16, wherein the inspection system comprises a computed tomography (CT) scanning system.

18. The method of claim 13, wherein the inspection system comprises a computed tomography (CT) scanning system.

19. The method of claim 13, wherein the residue is deposited beneath the electrical component soldered onto the substrate via the electrical connection material.
